(19) United States
(12) Patent Application Publication
(10) Pub. No.: US 2020/0282931 A1
(43) Pub. Date: Sep. 10, 2020

(54) ELECTRIC SERVO DRIVE FOR A MOTOR VEHICLE

(71) Applicant: Robert Bosch GmbH, Stuttgart (DE)

(72) Inventors: Frank SCHMIDT, Neckargmuend (DE); Jens GERSTENBERGER, Buehl (DE); Patrick KOENIG, Ottersweier (DE); Timo KUEHN, Oetigheim (DE); Vincent RIEGER, Karlsruhe (DE); Martin RAPP, Buehl (DE)

(21) Appl. No.: 16/063,693

(22) PCT Filed: Dec. 12, 2016
(86) PCT No.: PCT/EP2016/080600

§ 371 Date: Jun. 18, 2018

(30) Foreign Application Priority Data
Dec. 18, 2015 (DE) 102015225840.8

(51) Int. Cl. B60R 16/03; B60R 16/023; E05F 15/63

(52) U.S. Cl. CPC B60R 16/0315; E05F 15/63; B60R 16/0232

(57) ABSTRACT

The invention relates to an electric servo drive (10) for a motor vehicle, comprising an actuator (13) for at least indirectly moving an element (14) of the electric servo drive (10). According to the invention, the electric servo drive (10) additionally comprises at least one sensor element (15) which is designed to sense a measured variable that is not used for moving or actuating the element (14) of the actuator (13).

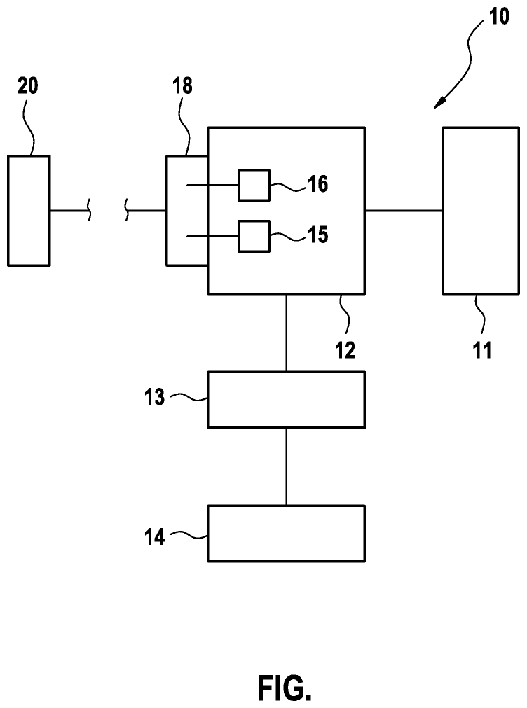

### BACKGROUND OF THE INVENTION

The invention relates to an electric actuating drive.

An electric actuating drive of this type and known in the prior art in the form of a comfort drive is by way of example configured as a window operating drive. The window operating drive comprises an actuator in the form of an electric motor having a gear that is flanged thereto so as to at least indirectly move the element (window pane) that is to be adjusted. The actuator is controlled in this case for example by an external operating unit that is arranged in a vehicle door. Furthermore, the electric actuating drive comprises sensors that are used by way of example to detect the position of the window pane, or by way of example to detect that an object has become jammed between the window pane and a door frame. Electric actuating drives of this type are consequently characterized by virtue of the fact that they represent units that are themselves closed and which at least essentially do not communicate with other units, be it another electric actuating drive or however units that are of higher-ranking importance. Also, the actuator that is provided in the electric actuating drive is primarily configured so as to perform the function of indirectly or directly actuating an element or a fluid medium. However, it is not provided that the actuator performs or fulfills other or higher-ranking functions.

### SUMMARY OF THE INVENTION

Based on the illustrated prior art, the object of the invention is to further develop an electric actuating drive for a motor vehicle in such a manner that these additional functions or tasks may be performed within the motor vehicle.

This object is achieved in accordance with the invention in the case of an electric actuating drive for a motor vehicle.

The invention in a first basic form is based in this case on the idea to configure the electric actuating drive in such a manner that said electric actuating drive comprises at least one sensor that is used to control or actuate other units but not however to control the electric actuating drive itself. By way of example, it is possible to provide that in addition a crash sensor for detecting a lateral impact is integrated in a window operating drive that is arranged in a door of the motor vehicle. A sensor element of this type is characterized in that said sensor element detects a measurement variable that is not used to adjust or actuate the element that is to be adjusted by means of the actuator of the actuating drive. The electric actuating drive that is described thus far in accordance with the invention is consequently characterized by virtue of the fact that said electric actuating drive assumes in part functions of another drive or another controller for an actuator without it being necessary to provide by way of example a separate installation space or a separate attachment to a vehicle door in order to perform this (additional) function. As a result, it is possible by way of example to reduce the assembly costs overall. It is also possible to use for example units of the electric actuating drive simultaneously for the additional at least one sensor element, by way of example a current or voltage supply for the electric actuating drive, said supply being provided in the electric actuating drive. As a result, it is possible to avoid the use for example of additional components, such as voltage supply lines for the additional sensor element, which would otherwise be necessary in the case of an arrangement that is separate from the electric actuating drive.

It is quite particularly preferred to provide an embodiment of the inventive idea described thus far in which in addition an interface is provided on the electric actuating drive, said interface being used to transmit the measurement variables of the additional sensor element to a unit that is external to the electric actuating drive. In other words, this means that the electric actuating drive is configured so as to communicate with an external unit in order to transmit to the external unit the measured variable that is detected by the at least one additional sensor element.

In a specific embodiment of an external unit of this type, said unit may be a unit that is arranged in the motor vehicle itself. By way of example, and not limiting, the unit that is arranged in the motor vehicle may be a safety device and/or a drive unit and/or a vehicle dynamics control unit. It is thus possible when using four window operating drives to equip each window operating drive with a position sensor and to transmit the signals from said position sensors to a vehicle dynamics control unit or electronic stabilizing control unit. It is possible to use the detected individual sensor signals to conclude the position of the vehicle with respect to a travel direction or similar in order to detect a skid situation or an instable driving state of the vehicle. It is likewise possible by way of example to use a vibration sensor, for example in the case of sliding roof drive, said vibration sensor detecting the vibration states or oscillation states of the vehicle as a result of movements in body parts. These signals may then be transmitted by way of example to an engine control unit, which for example increases the rotational speed in a range that is not noticeable for a driver in order to eliminate the oscillating state that has an adverse effect on the comfort factor.

An external unit of this type that has been described thus far is characterized in particular by virtue of the fact that said external unit comprises an actuating element that performs or fulfills a functionality in dependence upon the transmitted measurement variable.

However, it is also possible to provide that the external unit is a unit that is arranged outside the motor vehicle. The connection to such an external unit is produced by way of example via WLAN, GSM (mobile radio) Bluetooth etc. External communication with the motor vehicle is consequently possible in order by way of example to share information from the sensor element with other vehicle participants, for example in order to transmit warning signals. By way of example, in the event of an accident that is determined via a crash sensor that is arranged in the vehicle door in a window operating drive, it is possible to transmit a relevant signal to an emergency response center. It is also possible in the event of a predetermined external temperature not being achieved during the drive, said condition indicating a risk of black ice, to output via an internet connection in conjunction with a navigation system inside the vehicle a relevant warning or a relevant instruction for other vehicles that are present in the same area of traffic.

In an alternative embodiment of the basic idea of the invention, it is possible to provide that the electrical actuating drive comprises an actuator that is independent from the actuator, the former being controllable by an external unit via an interface. An actuator of this type may be configured by way of example in the form of a loudspeaker, a vibrator or similar. It is thus possible by way of example for a noise that is detected by a microphone in the region of a headrest to be transmitted as an input variable to an loudspeaker, which is arranged in an electric actuating drive, such as a window operating drive, in such a manner that the loudspeaker generates an antiphase in order to reduce the noise emission overall (noise cancellation principle).

In particular, the invention is used in the case of comfort drives that by way of example, and not limiting, are configured as a window operating drive, a seat adjustment drive or a sliding roof drive. The invention is however not limited to applications of this type. It is thus conceivable by way of example that the electric actuating drive is configured as an engine fan or similar.

Furthermore, an electric motor is preferably used as an actuator. The invention is however also to be used for other actuators, by way of example piezo elements or similar.

### BRIEF DESCRIPTION OF THE DRAWING

Further advantages, features and details of the invention are disclosed in the description below of preferred exemplary embodiments and with reference to the drawing.

The single drawing FIGURE illustrates in the single FIGURE a representation of the system of an electric actuating drive in a motor vehicle in a simplified view.

### DETAILED DESCRIPTION

An electric actuating drive 10 for a motor vehicle is illustrated in a greatly simplified manner in the single FIGURE. The electric actuating drive 10 may be by way of example and not limiting a comfort drive in the form of a window operating drive, seat adjustment drive or a sliding roof drive.

The electric actuating drive 10 comprises an operating unit 11 or for example a central control unit that communicates via a LIN-bus and that by way of example transmits a driver's request to open a window pane to a unit 12 that is arranged in a door. The unit 12 comprises in particular a control unit for controlling an actuator 13 that is configured for example as an electric motor and, by means of a transmitting element (not illustrated) adjusts an element 14 that is to be adjusted and is part of the electric actuating drive 10, in the case of a window operating drive a window pane, according to the driver's request.

In addition, by way of example at least one sensor element 15 and/or at least one further actuator 16 are arranged in the region of the unit 12. The sensor element 15 is used to detect a physical measuring variable that is used not to adjust or control the primary function of the electrical actuating drive 10, i.e. the adjustment of the element 14. The physical measurement variable may be by way of example a temperature, a force, a pressure, acceleration, airborne sound or structure-borne sound or similar. By way of example, a temperature sensor may be configured as an infrared array that is able to detect a temperature change over a predetermined area. By virtue of the temporal change, it is thus possible by way of example also to detect any undesired fluid occurring in or outside the electrical actuator drive 10. Alternatively, the infrared array may also detect the temperature distribution in the internal compartment of the vehicle, in particular at a high resolution, in order by way of example to individually control the air-conditioning system according to the climatic zones. In addition, the infrared array may also be used in this case to recognize a person in order to initiate safety measures in dependence upon the position of the persons in the event of a crash. It is also possible so as to control the climatic zones to integrate temperature sensors in multiple electrical actuating drives (10) that are arranged in a distributed manner, said temperature sensors then provide individual temperature values for different zones in the internal compartment. By way of example, temperature sensors in the seat drives may monitor the foot space, the window operating drives the middle region and the sliding roof drive the head space of the internal compartment and provide relevant temperature signals for adjusting the air-conditioning system. As a result, it is possible to realize a high resolution climatic zone control unit in the vehicle internal compartment.

In a further embodiment, the sensor element 15 is configured as an air quality sensor for the vehicle internal compartment, said sensor being able to detect the concentration of different gases in the air. In the event that predetermined limit values (for example for CO₂) are exceeded or not achieved, a signal may be output as a warning or to trigger auxiliary measures, such as automatic ventilation. It is possible using an array sensor to monitor the gas concentration simultaneously in different regions and thus by way of example also to detect early any smoke or fire development. In so doing, automatic auxiliary measures such as extinguishing the fire or placing an emergency call may be triggered.

The additional actuator 16 that is arranged in the unit 12 may be configured by way of example as a vibrator, loudspeaker or similar and is likewise not primarily used to drive or adjust the element 14.

Both the at least one sensor element 15 and also the at least one further actuator 16 are coupled to an interface 18 on the unit 12 by means of which the at least one sensor element 15 or the at least one additional actuator 16 may communicate or is controlled. In particular, the interfaces concerned may be standardized interfaces such as LIN, CAN, Flexray or similar interfaces 18. The interface 18 is used to communicate with a unit 20 that is external to the electrical actuating drive 10. The unit 20 may be either a unit 20 that is inside the vehicle, such as a device that is relevant for safety aspects of the vehicle, another electrical actuating drive, an engine control unit or a vehicle dynamics control unit. However, the invention is not limited to the mentioned units 20 that are inside the vehicle. It is likewise possible that the external unit 20 is an external unit 20 that is arranged outside the vehicle. In this case, the interface 18 is configured at least indirectly so as to communicate with the external unit 20 in particular via wireless communication means.

The invention described thus far may be converted or modified in numerous ways without departing from the inventive idea. Said inventive idea resides in allocating an additional functionality to an electrical actuating drive 10, said additional functionality being different to the actual, primary functionality of the electrical actuating drive 10.

In an alternative embodiment, an actuating drive may also comprise a sensor element 15 that generates on the one hand sensor signals that are processed for the adjustment procedure of the adjustment element and simultaneously provides an additional sensor signal that is not used for the adjustment procedure but rather is used for a function in the motor vehicle that is completely independent from the actuating drive. It is possible by way of example to use a measured temperature signal both for controlling the electric motor and also for detecting persons in the vehicle or for adjusting the air-conditioning system. Likewise, an acceleration signal from the actuating drive may be used both for preventing the actuating element from becoming jammed and also for other functions such as a passenger-retaining system in the event of a crash.

1. An electric actuating drive (10) for a motor vehicle, said electric actuating drive having an actuator (13) for at least indirectly moving an element (14) of the electric actuating drive (10), characterized in that the electric actuating drive (10) comprises in addition at least one sensor element (15) that is configured so as to detect a measurement variable that is not used to adjust or control the element (14) of the electric actuating drive (10) by means of the actuator (13).

2. The electric actuating drive as claimed in claim 1, further comprising an interface (18) configured so as to transmit the measurement variable of the sensor element (15) to a unit (20) that is external to the electric actuating drive (10).

3. The electric actuating drive as claimed in claim 2, characterized in that the external unit (20) is a unit (20) that is arranged in the motor vehicle.

4. The electric actuating drive as claimed in claim 3, characterized in that the external unit (20) is a safety device and/or a drive unit and/or a vehicle dynamics control unit.

5. The electric actuating drive as claimed in claim 3, characterized in that the external unit (20) comprises an actuating element.

6. The electric actuating drive as claimed in claim 2, characterized in that the external unit (20) is arranged outside the motor vehicle.

7. An electric actuating drive (10) for a motor vehicle, said electric actuating drive having a first actuator (13) for at least indirectly moving an element (14) of the electric actuating drive (10), characterized in that the electric actuating drive (10) comprises a further actuator (16) that is independent from the first actuator (13) and is configured to be controlled via an interface (18) on the actuating drive (10) by a unit (20) that is external to the actuating drive (10).

8. The electric actuating drive as claimed in claim 7, characterized in that the first actuator (13) is configured as an electric motor and the electric actuating drive (10) is a comfort drive.

9. The electric actuating drive as claimed in claim 7, characterized in that the sensor element (15) and/or the further actuator (16) are arranged in one unit (12) of the actuating drive (10), said unit being configured as a control unit for the first actuator (13), wherein the sensor element (15) and/or the further actuator (16) are configured as MEM components of the unit (12).

10. The electric actuating drive as claimed in claim 7, characterized in that the sensor element (15) is configured as a temperature sensor and/or a force sensor and/or a pressure sensor and/or an acceleration sensor and/or a sound sensor.

11. The electric actuating drive as claimed in claim 7, characterized in that the further actuator (16) is configured as a loudspeaker and/or a vibrator and/or a blocking or clamping element.

12. The electric actuating drive as claimed in claim 7, characterized in that the sensor element (15) is configured as a temperature sensor that detects the temperature distribution of climatic zones and/or of persons and/or of objects in the internal compartment of the vehicle.

13. The electric actuating drive as claimed in claim 7, characterized in that the sensor element (15) is configured as a gas sensor that monitors locally gas concentrations of an internal compartment air in the vehicle.

14. The electric actuating drive as claimed in claim 7, wherein further actuator (16) is configured to be controlled via an internet connection.

15. The electric actuating drive as claimed in claim 7, characterized in that the sensor element (15) is configured as an infrared array that detects the temperature distribution of climatic zones and/or of persons and/or of objects in the internal compartment of the vehicle, and the actuating drive (10) is arranged in a foot space and/or in a backrest region and/or in a headrest region and/or in a vehicle roof.

16. The electric actuating drive as claimed in claim 7, characterized in that the sensor element (15) is configured as a gas sensor array that monitors locally gas concentrations of an internal compartment air in the vehicle and is also used as a smoke and/or fire alarm and/or as a CO₂ monitor in order to trigger relevant emergency measures.

17. The electric actuating drive as claimed in claim 2, characterized in that the external unit (20) is arranged outside the motor vehicle and forms an internet connection to the actuating drive (10).

18. The electric actuating drive as claimed in claim 1, characterized in that the actuator (13) is configured as an electric motor and the electric actuating drive (10) is a comfort drive.

19. The electric actuating drive as claimed in claim 1, characterized in that the sensor element (15) and/or the further actuator (16) are arranged in one unit (12) of the actuating drive (10), said unit being configured as a control unit for the actuator (13), wherein the sensor element (15) and/or the further actuator (16) are configured as MEM components of the unit (12).

20. The electric actuating drive as claimed in claim 1, characterized in that the sensor element (15) is configured as a temperature sensor and/or a force sensor and/or a pressure sensor and/or an acceleration sensor and/or a sound sensor.

21. The electric actuating drive as claimed in claim 1, characterized in that the further actuator (16) is configured as a loudspeaker and/or a vibrator and/or a blocking or clamping element.

22. The electric actuating drive as claimed in claim 1, characterized in that the sensor element (15) is configured as a temperature sensor that detects the temperature distribution of climatic zones and/or of persons and/or of objects in the internal compartment of the vehicle.

23. The electric actuating drive as claimed in claim 1, characterized in that the sensor element (15) is configured as a gas sensor that monitors locally gas concentrations of an internal compartment air in the vehicle.

24. The electric actuating drive as claimed in claim 1, characterized in that the sensor element (15) is configured as an infrared array that detects the temperature distribution of climatic zones and/or of persons and/or of objects in the internal compartment of the vehicle, and the actuating drive (10) is arranged in a foot space and/or in a backrest region and/or in a headrest region and/or in a vehicle roof.

25. The electric actuating drive as claimed in claim 1, characterized in that the sensor element (15) is configured as a gas sensor array that monitors locally gas concentrations of an internal compartment air in the vehicle and is also used as a smoke and/or fire alarm and/or as a CO₂ monitor in order to trigger relevant emergency measures.
